(19) United States
(12) Patent Application Publication
(10) Pub. No.: US 2014/0272859 A1
(43) Pub. Date: Sep. 18, 2014

(54) Mobile Application for Multilevel Document Navigation

(71) Applicant: CHEGG, INC., Santa Clara, CA (US)

(72) Inventors: Mike Mueller, Campbell, CA (US); Shannyn Timrott, San Jose, CA (US); Aviel Lazar, Herzlliyz (IL); Simon Hanukaev, Holon (IL); Ohad Eder-Pressman, San Francisco, CA (US); Vincent Le Chevalier, San Jose, CA (US); Charles F. Geiger, San Jose, CA (US)

(73) Assignee: Chegg, Inc., Santa Clara, CA (US)

(21) Appl. No.: 13/861,542

(22) Filed: Apr. 12, 2013

Related U.S. Application Data
(60) Provisional application No. 61/794,221, filed on Mar. 15, 2013.

(51) Int. Cl. G09B 5/02

(52) U.S. Cl. CPC G09B 5/02
USPC 434/257

(57) ABSTRACT

Embodiments provide a user-friendly mobile interface for presenting multistep exercises of a dynamic exercise layer in a multilayered textbook within a digital education platform. The mobile interface comprises a variety of elements facilitating navigating, commenting, rating and interacting with the multistep exercises. A first interface element of a picker tab allows users to navigate the plurality of exercises and make selections. Once an exercise is selected from the picker tab, the mobile interface displays the exercise in a second interface element of a window, by showing one or more cascading steps of the selected exercise.

### CROSS-REFERENCE TO RELATED APPLICATION

This application claims the benefit of U.S. Provisional Application No. 61/794,221, filed on Mar. 15, 2013, which is incorporated by reference in its entirety.

### BACKGROUND

This invention relates to presenting multilayered digital textbooks to users of mobile devices in a digital education platform.

The successes of electronic book content offering and services have confirmed that readers at large were ready to migrate from print to digital content. Consumer adoption has been validated across a wide distribution of gender, age and geography as this shift accelerated all around the world. From a technical perspective, this commercial success is due in part to the adoption of ePUB, the open e-book standard by the International Digital Publishing Platform (IDPF). The format, designed primarily for reflowable content, is meant to function as a single format that publishers and conversion houses can use in-house, as well as for distribution and sale. The ePUB format and other related formats, with its embedded metadata and single file packaging approach, has proven to be a good solution to off-line reading mode of tradebooks and similar documents. But while providing excellent reading user experience for this new digital medium remains a focus of the commercially available eReading systems and applications, it has been so far much more difficult to fully integrate other related reading activities, such as presenting exercises and interactive problem solving for example.

Furthermore, the rapid shift to mobile Internet services is bringing content offerings to an increasingly larger number of connected user devices. Experiences previously limited to a single device are now accessible across multiple devices as high volume consumer electronic platforms such as Smart Phones, tablets, eReaders, game systems, and Internet TVs have become new channels to receive digital documents and services. Most importantly, as digital documents shift from a static model to a dynamic model, in which related, personalized, and social content are aggregated dynamically within the original document, publishing services must be able to manage and distribute these new content layers across a plurality of connected devices, each with unique attributes affecting the reading experience.

### SUMMARY

The goal of embodiments of the described mobile application is to provide a system and method to users for navigating, browsing, reading, commenting and interacting with multistep exercises in multilayered textbooks within digital education platforms. Embodiments of the mobile application leverage a digital education platform's overall understanding of HTML5 document services and eReading systems for digital content distribution and consumption.

The mobile application provides a user-friendly mobile interface for presenting multistep exercises of a dynamic exercise layer in a multilayered textbook within a digital education platform. In one embodiment, the mobile interface comprises a variety of elements facilitating navigating, commenting, rating and interacting with the multistep exercises. For example, a first interface element of a picker tab allows users to navigate the plurality of exercises and make selections. Once an exercise is selected from the picker tab, the mobile interface displays the exercise in a second interface element of a window, by showing one or more collapsible steps of the selected exercise. A third interface element allows users to rate the viewing exercise. In a fourth interface element, users can leave comments to each step of the exercise and share the comments with their social connections.

### BRIEF DESCRIPTION OF THE DRAWINGS

FIG. 1 is a high-level block diagram illustrating a system environment for an educational digital content publication and reading platform according to one embodiment.

FIG. 2 is a block diagram illustrating an example of multilayered textbook according to one embodiment.

FIGS. 3A-3D are screenshots illustrating an example user interface of the mobile application for presenting exercises according to one embodiment.

FIGS. 4A-4C are screenshots illustrating an example user interface of the mobile application for user comments according to one embodiment.

FIGS. 5A-5B are screenshots illustrating an example user interface of the mobile application for user login according to one embodiment.

FIG. 6 is a flowchart illustrating a method for presenting an exercise layer of a multilayered textbook in a mobile application according to one embodiment.

One skilled in the art will readily recognize from the following discussion that alternative embodiments of the structures and methods illustrated herein may be employed without departing from the principles of the invention described herein.

### DETAILED DESCRIPTION OF THE EMBODIMENTS

### Overview

Embodiments of the present invention provide a system and method for presenting an exercise layer in a multilayered textbook in a mobile application. The system is built upon an educational digital publishing and reading platform (hereinafter referred to as “the digital education platform” or “the platform”) configured to aggregate, manage, and distribute multilayered textbook content. The textbook in modern markup language format can be downloaded to general eReading applications (e.g., a HTML5 compatible browser) on a page by page basis and can be easily expanded to support a multilayered structure so as to incorporate supplemental content, such as dynamic listing of exercises and user-generated content in additional layers. The digital education platform also manages an educational social network that provides learning and reading services to the participating users, such as teachers, students and authors. Users may join the social network to interact (e.g., comment on the exercise steps) through connected desktop and mobile devices.

FIG. 1 is a high-level block diagram illustrating an environment 100 for the digital education platform, which comprises textbook source 101, a digital education platform 102, a network 103, and one or more user devices 104. The network 103 is typically a content delivery network (CDN) built on the Internet, but may include any network, including but not limited to a LAN, a MAN, a WAN, a mobile wired or wireless network, a private network, or a virtual private network. The user devices 104 access the textbook content from eReading browser applications running on computing devices connected to the network 103. The user devices 104 include a personal computer, such as a desktop, laptop, or tablet computer, a personal digital assistant, a mobile or smart phone, or a television “set-top box” using a client web application.

The textbook source 101 include digital and printed textbook content automatically gathered and aggregated from a large number of publishers, categories, and partners. Examples of content include textbooks, exercises, user-generated content, web content, and advertising content. Textbook content is automatically collected from various sources into a formalized staging environment.

The digital education platform 102 aggregates, validates, transforms, packages, and monetizes the textbook content collected by the textbook source 101 into a number of services, prior to distribution to the user devices 104 over the network 103. The platform comprises five modules: ingestion system 120, publishing system 130, distribution system 140, social network engine 150, and exercise production system 160. Other embodiments may include more or fewer and/or different modules.

The ingestion system 120, including staging, validation, and normalization subsystems, ingests published documents that may be in a variety of different formats, such as PDF, ePUB2, ePUB3, SVG, XML, or HTML. The ingested document may be a book, such as a textbook, a set of self-published notes, or any other published documents, and may be subdivided in any manner. For example, the document may have a plurality of pages organized into chapters, which could be further divided into one or more sub-sections. Each page may have text, images, tables, graphs, or other items distributed across the page.

After ingestion, the documents are passed to the publishing system 130. If the document ingested by the ingestion module 120 is not in a markup language format, the publishing system 130 automatically identifies, extracts, and indexes all the key elements and composition of the document to reconstruct it into a modern, flexible, and interactive markup language document, for example, an HTML5 web page well-suited for distribution across various computing devices. The transformed content preserves the original page structure including pagination, number of columns and arrangement of paragraphs, placement and appearance of graphics, titles and captions, and fonts used, regardless of the original format of the source content and complexity of the layout of the original document. In one embodiment, the publishing system 130 reconstructs published documents so as to accommodate dynamic add-ons, such as related content, while maintaining page fidelity to the original document.

After reconstructing a document, the distribution system 140 packages content of the digital education platform 102 for delivery, uploads the content to content distribution networks, and makes the content available to end-users based on the content's digital rights management policies. The distribution system 140 may also aggregate additional content as layers on top of the foundation layer of original document from numerous sources. These layers, including related content, user-generated content, and advertising content, may be added to the document to create a dynamic, multilayered document. More details of the multilayered digital document are described with reference to FIG. 2 below.

The social network engine 150 creates and manages an educational social network among users of the education digital education platform. For each individual user, the social network engine 150 automatically discovers and recommends social connections to the user based on user profile and other information about the user. Once connected through the education social network, users of the digital education platform 102 may interact with each other, for example, sharing user-generated content, commenting on classes, textbooks or exercises, and collaborating with each other on projects and activities.

The exercise production system 160 identifies, aggregates, and monetizes exercise content, such as examples, problems, and solutions for textbooks from various sources (e.g., textbook source 101) into a dynamic exercise layer and an exercise service for the digital education platform. Based on the identified exercises, the exercise production system 160 generates a dynamic HTML exercise document layer configured for presentation to all users, or groups of users, through a mobile exercise application for user devices 104. The dynamic exercise layer is associated with the foundation layer document and can be displayed side by side with the corresponding textbook sections on multiple devices connected to the digital education platform 102.

In the digital education platform 102 included in the digital education environment 100 as illustrated in FIG. 1, each user is associated with an account on the digital education platform 102, and textbooks purchased by the user through the digital education platform 102 is made available through the user account. In one embodiment, the user devices 104 may also be registered to the account to authorize the devices for accessing content services. Alternatively, the digital education platform 102 may establish an authenticated web session on a user device 104 when the user requests to access content of the digital education platform 102 from the user device 104. Furthermore, a user may access and interact with multilayered textbook synchronously on a plurality of user devices 104. In one embodiment, a user may simultaneously use one or more user devices 104, such as a desktop computer, a laptop, a smart phone, a tablet, an eReader, an Internet television, or any other device including computing functionality and data communication capabilities, to interact with different layers of the multilayered textbook distributed by the digital education platform 102. For example, the user may be reading the textbook using an eReading browser application 106 on the user device 104A while going through exercises on the user device 104B using a mobile exercise application 108.

### Multilayered Textbook

A multilayered digital textbook comprises a foundation layer and one or more additional content layers. The foundation layer is a standalone textbook comprising one or more pages of the published textbook, ingested by the digital education platform and transformed into a markup language format while preserving the page fidelity. The one or more additional layers of the multilayered digital textbook include supplemental content, related content, and user-generated content associated with the pages of the foundation layer. The multilayered digital textbook represents services hosted by the digital education platform and is accessible by eReading browser applications executing on one or more connected user devices.

FIG. 2 is a block diagram illustrating an example of multilayered digital textbook according to one embodiment. It illustrates pages P1-P6 in a foundation layer 201 from an original textbook, an exercise layer 202, a social content layer 203, and an advertising layer 204. The foundation textbook layer 201 contains textbook pages ingested and/or reconstructed by the digital education platform 102, which include all the page elements (e.g., text, graphs, charts, images, and tables), page info (e.g., pagination, arrangement, and placement) and metadata (e.g., element type, description, pricing, and terms). The exercise layer 202, social content layer 203, and advertising layer 204 are the supplemental dynamic layers that may be shared, purchased or downloaded in conjunction with the foundation layer 201.

When converting ingested data, the digital education platform identify additional content for the exercise layer 202 to supplement the converted foundation textbooks and other documents. Examples of the additional content for the exercise layer 202 include, but are not limited to, study guides, examples, questions, self-testing material, and solution manuals, among other references, that are directly related to the content of the textbook and its structure. The digital education platform 102 adds the additional content to the exercise layer 202 of the converted textbook and associates each item of the related content with a corresponding page or section of the foundation textbook. For example in FIG. 2, exercise R3 with items (E₁:E_{M}) and exercise R6 with items (E₁:E_{N}) are associated with pages 3 and 6 respectively. The exercise layer is dynamic in that exercises can be presented to users based on their performance, progress and preferences. For example, additional and more challenging exercises can be unlocked and presented to users as they advance through the exercises.

The social content layer 203 includes content uploaded to the digital education platform by the users and shared with other users (e.g., classmates, teachers, authors, etc.) from the user's education social connections. Examples of social content include interactions between users related to the textbook and content shared by friends in the user's social networks, such as annotations S2 and S4 made and shared by users during an eReading web session including highlighting or notes, and user comments S3 and S6 made by users in relation to the exercises listed in R3 and R6 respectively.

Advertisement content may be uploaded by advertisers or advertising agencies to the digital education platform. The advertising layer 204 is also dynamic in that the advertisements may be updated during user web sessions. Advertisements delivered to a user may be selected by the digital education platform based on the textbook the user is interacting with and the user's activities. As the supplemental layers of the textbook accessed by the user is getting updated dynamically, or as the user's activities are shifting during the web sessions, the digital education platform may update the advertisements. In FIG. 2, for example, advertisements are present in the advertising layer 204 for the pages 1, 3 and 5.

Although only four layers are shown in the example in FIG. 2, multilayered textbooks may contain fewer or more and/or different layers of content. After a multilayered textbook is constructed, content distribution system 140 distributes content dynamically and on-demand through authenticated web sessions to users each time they request access to multilayered textbook services.

### Mobile Application Interface

The mobile application is designed with an interface for easy navigation of the multistep exercises included in the exercise layer of a multilayered digital textbook on mobile device. In one embodiment, the mobile interface comprises at least a first element of a picker tab that allows users to navigate the plurality of sections and exercises and make selections. When tapped, the picker tab expands into two horizontal scroll menus: one for presenting a sequence of section identifiers extracted from the foundation textbook structure so that users can browser and select any section identifiers in the multilayered textbook; the other for displaying a dynamic list of exercise identifiers identifying one or more exercises corresponding to each of the sections. Once an exercise is selected from the scroll menus, the mobile interface displays the selected exercise in one or more steps in a second element of a main window in the mobile interface. Users may go through the exercise step by step and leave personal comments to each step. Users can also rate the exercise they are viewing and share the comments and rating with their social connections. The mobile application can optionally be used as a remote control for a textbook eReading environment where multiple devices are connected.

FIGS. 3A-3D illustrate screenshots from an example user interface of the mobile application for presenting exercises according to one embodiment. In this example, the mobile interface 300 comprises a title bar 302, an information button 304, a main window 306, a picker tab 310, and a rating bar 330. Other embodiments may include fewer or more user interface elements and/or different types of elements in the mobile interface.

FIG. 3A is a screenshot illustrating an example introduction screen of the mobile interface 300 displayed when a user opens the mobile application to access the exercise layer in a digital multilayer textbook for the first time. The textbook title “Calculus 101” is shown in the title bar 302. The information button 304 is located in the title bar 304, and when tapped, displays more detailed textbook and purchase information. The main window 306 displays an initial usage tip for the mobile application, for example, a message on rotating the mobile device for best viewing experience. Other tips for the use of the picker tab 310 and the rating bar 330 are also shown on top of the respective elements in the main window. The picker tab 310 is collapsed by default.

FIG. 3B is a screenshot illustrating an example of the picker tab 310 of the mobile interface 300. As shown in FIG. 3B, the picker tab 310 has expanded into a view pane showing a section scroll menu 312 on the top row and an exercise scroll menu 314 at the bottom for navigating and selecting textbook sections and exercises included in the sections. In this example, the section scroll menu 312 displays a sequence of five section identifiers (from section 12.1.7 to 12.2.2) in the view pane. However, more or less section identifiers can be shown, for example, when the mobile device is rotated. As users swipe the section scroll menu 312, different sequences of section identifiers will be displayed allowing the users to navigate to any section of the textbook. Similarly, users can swipe the exercise scroll menu to navigate to any exercises included in the textbook.

In one embodiment, while users swipe the section scroll menu 312 to navigate to a respective section of the textbook, the corresponding list of exercises in the respective section is displayed in the exercise scroll menu 314. If there is no exercise included in the section, the corresponding exercise scroll menu will be empty. Otherwise, a list of exercise identifiers included in the respective section is displayed. Users can tap to select a section identifier and an exercise identifier such that the exercise identified by the selected section identifier and exercise identifier is shown in the main window 306. A tap on the picker tab 310 again will close the section and exercise scroll menu.

FIG. 3C is a screenshot illustrating an example of multistep exercise presentation in the mobile interface 300. In this example, a user selected exercise with section identifier “12.2.1” and one of its exercise identifiers “1E” is displayed in the main window 306. The exercise includes five steps 312-325, which are presented in five collapsible rows, each row can be collapsed to a bar showing a step index and a comment button 402. As shown in FIG. 3C, the first step 321 on the top row is automatically expanded to show the content of the first step after the exercise is selected, while steps 322-325 remain collapsed. In one embodiment, when users proceed to the next step, for example, by tapping the second step 322, the second step 322 will be expanded to show the content while the first step 312 is collapsed. Other embodiments may keep the previous steps expanded so users can refer back to previous steps at any time.

FIG. 3D is a screenshot illustrating an example of rating bar 330 in the mobile interface 300. Colored stars in the rating bar 330 shows the current average rating of the exercise presented in the main window 310, and the number in parenthesis represents a number of total users that have rated the exercise. Users can tap on the rating bar 330 to bring out a user rating input element 332 as shown in FIG. 3D. In this example, a one to five stars rating scale is used so a user may color a number of stars for rating the exercise (e.g., 3-star rating). Once the user inputs his or her rating, the rating bar 330 will update its display of the average rating and the total number of users that have rated the exercise.

FIGS. 4A-4C are screenshots illustrating an example user interface of the mobile application for user comments according to one embodiment. When a user taps the comment button 402 in a step bar (e.g., shown in FIG. 3C), a comments screen 400 is displayed in the mail window of the mobile interface. In this example, three users from an educational social network share their comments on the current step of the exercise. At the bottom of the comments screen, a text field 402 is present allowing the view user to input his or her personal comments. By a tap inside the text field, a virtual touch keyboard 404 pops up, this allows the user to post comments as shown in FIG. 4B. The user comments are self-moderated in a sense that users may challenge any posted comments by reporting abuses. This can be done through an option sheet 406, which can be activated, for example, by pressing and holding a comment item. An example of the abuse reporting option sheet is shown in FIG. 4C containing various abuse types.

Another element of the mobile interface is an exercise layer subscription interface as shown in FIGS. 5A and 5B. In the digital education environment 100 including the digital education platform 102 illustrated in FIG. 1, each user is associated with an account on the digital education platform 102, and textbooks purchased by the user through the digital education platform 102 are made available through the user account. A user may purchase a multilayered textbook as a whole, including the foundation layer textbook and dynamic exercise layer. The user may also purchase different layers separately. In either case, the licensing of the exercise layer is independently managed by the digital education platform 102. Hence, users need to register to access supplemental layers (e.g., the exercise layer) of the multilayered textbook through an authentication interface 502 shown in FIG. 5A. For example, users are first required to sign up to the exercise layer service in order to sample a couple of exercises available for free. On-going access is secured by the selection of a purchase plan, as shown in the pop up window 504 in FIG. 5B.

Generally, the textbook exercise layer is offered as one of the supplemental content layers of multilayered textbooks. Various licensing model can be applied to the supplemental content including the exercise layer in a multilayered textbook, such as free licensing where unlimited access is given to users, and time limited access where a subscription is purchased. Users may have the flexibility to choose their subscription plans, for example, monthly or annual subscriptions.

In one embodiment, users may access a multilayered textbook from a plurality of interconnected devices communicatively coupled to the digital education platform, each device having different attributes. Attributes of different device affect the system resources available to the eReading application executing on each device. Therefore, one user device may be more suitable than another for accessing and enabling user interaction with a particular document layer. For example, a user may choose to access the dynamic step-by-step exercise layer from a mobile phone or tablet while displaying the foundation layer of a multilayered textbook on a desktop computer with larger screens. In one embodiment, the mobile application executed on the mobile devices may function as a remote control for the eReading browser application running on a secondary display. For instance, when the user navigates and selects a particular exercise from the section/exercise picker tab of the mobile interface on user device 104B as shown in FIG. 1, the eReading browser application executing from the desktop computer 104A is synchronized with the mobile exercise application running on the user device 104B. The section or page of the textbook corresponding to the user selected exercise can be determined (e.g., by a user selection of the section identifier from the section scroll menu 312 as shown in FIG. 3B), and the foundation layer of the textbook on the user device 104A is refreshed and displayed accordingly.

FIG. 6 is a flowchart illustrating a method for presenting a dynamic exercise layer of a multilayered textbook in a mobile application according to one embodiment. In the described embodiment, the steps of the method are performed by the digital education platform 102. Other embodiments perform the illustrated steps in different orders, and/or perform different or additional steps.

In one embodiment, the mobile application displays 602 a sequence of section identifiers in a first scroll menu for users to navigate to any section in the multilayered textbook. A list of exercise identifiers is displayed 604 in a second scroll menu for users to select an exercise from one or more exercises included in a section of the multilayered textbook. For example, the picker tab 310, with reference to FIG. 3B, can be expanded into a view pane to show the section scroll menu 312 and the exercise scroll menu 314 from which users navigate and make selections on a section identifier and/or an exercise identifier.

In step 606, a user selection of an exercise is received, for example by user selection of a section identifier and/or an exercise identifier displayed. To select an exercise, a user may first navigate to a new section identifier from the section scroll menu 312 and select an exercise from a list of exercise identifiers associated with the new section from the exercise scroll menu 314. Alternatively, if the user just proceeds to the next exercise in the same section, he or she can simply select the next exercise identifier from the exercise scroll menu 314 without the need to swipe the section scroll menu 312.

After the user selects 606 an exercise based on at least one of a displayed section identifier and a displayed exercise identifier, the mobile application displays 608 the user selected exercise in one or more collapsible rows in the mobile device display, each row corresponding to a step of the exercise. In one embodiment, the first step of the exercise is automatically expanded to show the content of the first step while other steps remain collapsed. When the user proceeds to the next step, the second step is going to be expanded to show the content and the first step will be collapsed. For example, a five-step exercise with section identifier “12.2.1” and exercise identifier “1E” is displayed in the main window 306, with reference to FIG. 3C. The first step 321 on the top row is automatically expanded to show the content while steps 322-325 remain collapsed.

In conclusion, the mobile application provides a user interface tailored for the easy navigation of dynamic listing of exercises in a multilayered textbook. The mobile user interface includes a picker tab allowing users to navigate and make selections of the listed exercises. Once a particular exercise is selected, the mobile interface displays the multistep exercise in collapsible rows so that users can go through the exercise step by step. Users may leave personal comments on each step and share their comments with friends in an education social network. The mobile application can also remotely control a display on a secondary device connected to the same education and eReading platform on which the associated textbook is displayed. Thus, users can conveniently navigate, browse, read, comment on and interact with multistep exercises in multilayered textbooks within a digital education platform.

### Additional Configuration Considerations

The present invention has been described in particular detail with respect to several possible embodiments. Those of skill in the art will appreciate that the invention may be practiced in other embodiments. The particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer and run by a computer processor. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

In addition, the present invention is not limited to any particular programming language. It is appreciated that a variety of programming languages may be used to implement the teachings of the present invention as described herein, and any references to specific languages, such as HTML5, are provided for enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

What is claimed is:

1. A method of presenting an exercise in a multilayered textbook on a mobile device display, the method comprising:
displaying a sequence of section identifiers in a first scroll menu for navigating to any section in the multilayered textbook;
displaying a list of exercise identifiers in a second scroll menu for selecting an exercise from one or more exercises included in a section of the multilayered textbook;
receiving a user selection of an exercise based on a user selection of at least one of a displayed section identifier and a displayed exercise identifier; and
responsive to the user selection of an exercise, displaying the user selected exercise in the mobile device display in one or more collapsible rows, each row corresponding to a step of the exercise.

2. The method of claim 1, wherein the first scroll menu and second scroll menu are horizontal pickers, and the first scroll menu is placed above of the second scroll menu.

3. The method of claim 2, wherein the first and second scroll menus slide up when an exercise selection tab at the bottom of the mobile device display is selected.

4. The method of claim 1, wherein the user selection of an exercise comprises a selection of exercise identifier from the second scroll menu.

5. The method of claim 1, wherein the user selection of an exercise comprises a selection of a section identifier from the first scroll menu and a selection of exercise identifier from the second scroll menu.

6. The method of claim 1, wherein displaying the user selected exercise in one or more collapsible rows comprises automatically expanding a first row to show content of the first step of the exercise while displaying other rows in a collapsed state.

7. The method of claim 6, wherein displaying the user selected exercise in one or more collapsible rows further comprises:
expanding a next row to show the content of a next step of the exercise; and
collapsing the expanded row corresponding to the previous step.

8. The method of claim 6, wherein displaying the user selected exercise in one or more collapsible rows further comprises:
expanding a next row to show content of a next step of the exercise while keeping the current expanded row expanded.

9. The method of claim 1, further comprising:
receiving a user comment on a respective step of the displayed exercise; and
displaying a total number of received user comments associated with the respective step of the displayed exercise.

10. The method of claim 1, further comprising:
receiving a user rating for the displayed exercise; and
displaying an overall rating for the displayed exercise including the received user rating.

11. The method of claim 1, wherein the multilayered textbook comprises a foundation layer of one or more pages of the textbook, and an exercise layer of a plurality of exercises, each exercise associated with a section of the multilayered textbook.

12. The method of claim 11, further comprising:
receiving a user credential for a subscription to the exercise layer of the multilayered textbook; and
responsive to authenticated user credential for the subscription, providing the user time-limited access to the plurality of exercises.

13. The method of claim 11, wherein the subscription to the exercise layer is independent from a license for the foundation layer of the multilayered textbook.

14. The method of claim 11, further comprising:
determining a section of the foundation layer associated with the user selected exercise; and
displaying the determined section of the foundation layer on a connected secondary user device.

15. A user interface of a mobile application for navigating a plurality of exercises on a mobile device display, the user interface comprising:
a first scroll menu displaying a sequence of section identifiers for navigating to any section in a foundation layer of a multilayered textbook;
a second scroll menu displaying a list of exercise identifiers for selecting an exercise from an exercise layer of the multilayered textbook comprising one or more exercises, each exercise associated with a section of the foundation layer;
wherein an exercise is selected by a user based on a user selection of at least one of a displayed section identifier and a displayed exercise identifier; and
a view window displaying the user selected exercise in one or more collapsible rows, each row corresponding to a step of the exercise.

16. The user interface of claim 15, wherein the first scroll menu and second scroll menu are horizontal pickers, and the first scroll menu is placed above of the second scroll menu.

17. The user interface of claim 16, wherein the first and second scroll menus slide up when an exercise selection tab at the bottom of the mobile device display is selected.

18. The user interface of claim 15, wherein displaying the user selected exercise in one or more collapsible rows comprises automatically expanding a first row to show content of the first step of the exercise while displaying other rows in a collapsed state.

19. The user interface of claim 15, further comprising:
a popup window for receiving a user credential for a subscription to the exercise layer of the multilayered textbook; and
wherein responsive to authenticated user credential for the subscription, displaying in the popup window information on time-limited access to the plurality of exercises.

20. The user interface of claim 15, wherein the user selected exercise causes a display of a section of the foundation layer on a connected secondary user device, the displayed section associated with the user selected exercise.
